(19) United States
(12) Patent Application Publication
(10) Pub. No.: US 2022/0300942 A1
(43) Pub. Date: Sep. 22, 2022

(54) SECURE MOBILE PAYMENT ACCEPTABLE AS CONTACTLESS PAYMENT FOR ON-SHELF TRADE DEVICES, AND BACK OFFICE APPLICATION SOLUTION

(71) Applicant: YAZARA PAYMENT SOLUTIONS INC., Lewes, DE (US)

(72) Inventors: Ahmet AKGÜN, Istanbul (TR); Hasan YASSIBAS, Istanbul (TR)

(21) Appl. No.: 17/429,534

(22) PCT Filed: Nov. 13, 2020
(86) PCT No.: PCT/TR2020/051104

§ 371 Date: Aug. 9, 2021

(30) Foreign Application Priority Data
May 13, 2020 (TR) 2020/07461

(51) Int. Cl. G06Q 20/32; G06Q 20/38

(52) U.S. Cl. CPC G06Q 20/326; G06Q 20/3829; G06Q 20/3278; G06Q 20/4016

(57) ABSTRACT

Disclosed are a system and method providing use of related mobile devices as a POS device by use of an application running on mobile devices such as smart phones and tablets owned by the user.

### TECHNICAL FIELD

invention relates to a system and method meeting functions and requirements of physical POS devices by use of mobile devices.

Invention particularly relates to a system and method providing use of related mobile devices as POS device by use of application running on mobile devices such as smart phone, tablet, etc. owned by user.

### PRIOR ART

Pos devices in use in present art are hardware devices that running on fully close circuit network. Therefore, the required cryptographic keys are loaded at a certain location by the acquirer before sending it to the merchant. Installation of POS devices, updating software, in case of software defaults, since remote attempt is not possible in case of failure to function, field operation teams are needed. And it causes an operation cost.

In conclusion, it has been necessary to invent a novelty in the present art for the above-mentioned issues not having been solved in the light of the related art.

### BRIEF DESCRIPTION OF THE INVENTION

In order to eliminate above mentioned disadvantages and bring new advantages in the related technical field present invention relates to secure mobile payment and back office application solution capable to accept contactless payment for COTS (commercial off the shelf) devices.

Primary purpose of the invention is to develop a system and method to reduce risks that may be caused by hackers by means of providing performance of functions provided by conventional physical POS devices to user by mobile devices such as smart phone, tablet etc., and providing data security.

Another purpose of the invention is to provide a system and method providing security measure application against security threats by RASP mechanism, White box cryptography, communication protection, backend system protection mechanism, random number generation, session management.

Another purpose of the invention is to disclose a system and method developed in multi-tenant logic (supporting more than one acquirer through same system).

Another purpose of the invention is to provide a system and method capable to offer service to more than one acquirer bank by locating at an operation centre while it can operate only for one single acquirer bank.

In order to achieve all purposes mentioned above and to be understood better with the details given below, the present invention is a secure mobile payment and back office application system capable to accept contactless payment for all commercial of the shelf devices providing performance of functions of physical POS devices through mobile devices. Accordingly, the system comprises;
POS application comprising, enabling user to accept payments with the NFC (near field communication) enabled mobile device(M)
   UI/UX module that providing user interface,
   L3 SDK layer managing user interface and workflows,
   L2 kernel where core applications of payment schemeswork,
   L2 management module providing management of said L2 kernel,
   Crypto engine module providing generation of security, key and cryptographic algorithm operation
Backend module comprising, managing said POS application and
   A parameter management module that providing management of EMV terminal parameters on mobile device (M),
   Key management module providing management of client keys on mobile device (M),
   Transaction network gateway providing secure transmission of contactless payment transaction initiated on mobile device to acquirer bank in a secure way,
   Attestation and monitoring module verifying mobile device (M) and fraud checks,
   ID&V component providing integration of acquirer bank with merchant,
   Database storing key details,
   Hardware security module providing key management and communication security,
user mobile device running said POS application and having near field communication feature.

Invention also covers secure mobile payment and back office application method capable to accept contactless payment for commercial off the shelf devices, providing performance of functions of physical POS devices by mobile devices. According to it, the method comprises process steps of:
installation of POS application providing making payment, onto user mobile device having near field communication feature,
starting up of POS application on user mobile device and verification of initial attestation data,
verification of merchant,
generation of unique keys for merchant,
Downloading configuration and POS application parameters into user mobile device and completion of installation and getting POS application ready,
Performing sale transaction by POS application as follows;
   Starting of sale transaction by means of U/UX module, L3 SDK layer and L2 management module in POS application from POS application,
   receipt of data from said L3 SDK layer and L2 layer and preparation of EMV tags needed for authorization and encryption of sensitive data by crypto engine module providing running of cryptographic algorithms,
   submission of authorization request message to backend module that managing POS application via L2 management module,
   re-encryption of data by hardware security module providing key management and communication security in backend module and submission of authorization request message to acquirer bank by transaction network gateway in backend module,
   delivery of authorization request reply to transaction network gateway in backend module by acquirer bank,
   transmission of authorization request response from acquirer bank to L3 SDK layer in POS application by transaction network gateway in backend module,
   display of response of sale transaction result transmitted to L3 SDK layer in POS application by UI/UX module,
Performing void(cancellation)/refund transaction by POS application as follows;
   Starting of void/refund transaction by means of UI/UX module, L3 SDK layer and L2 management module in POS application from POS application,
   receipt of data from said L3 SDK layer and L2 layer and preparation of EMV tags needed for void/refund transaction and encryption of sensitive data by crypto engine module providing running of cryptographic algorithms,
   submission of void/refund request message to backend module managing POS application via L2 management module,
   re-encryption of data by hardware security module and transmission of void/refund request message to transaction network gateway in backend module to acquirer bank,
   transmission of void/refund request response from acquirer bank to L3 SDK layer in POS application by transaction network gateway in backend module,
Performing reversal transaction by POS application as follows;
   Receipt of an error from POS application during step of transmission of authorization request response from acquirer bank to L3 SDK layer in POS application by transaction network gateway in backend module,
   transmission of CheckPOS request and reversal request of POS application to backend module by L2 management module,
   transmission of reversal request to acquirer by backend module via transaction network gateway,
   transmission of reversal request response from acquirer bank to L3 SDK layer in POS application by transaction network gateway in backend module,
execution of reversal transaction by backend module as follows,
   receipt of error during step of delivery of authorization request response to transaction network gateway in backend module by acquirer bank,
   transmission of reversal request to acquirer by backend module via transaction network gateway,
   transmission of reversal request response from acquirer bank to L3 SDK layer in POS application via transaction network gateway in backend module.

In order to make the embodiment and additional members being subject of the present invention as well as the advantages dearer for better understanding, it should be assessed with reference to the fallowing described figures.

### BRIEF DESCRIPTION OF THE FIGURES

FIG. 1 is a schematic view of the system disclosed under the invention.

FIG. 2 is flow chart diagram of method disclosed under the invention.

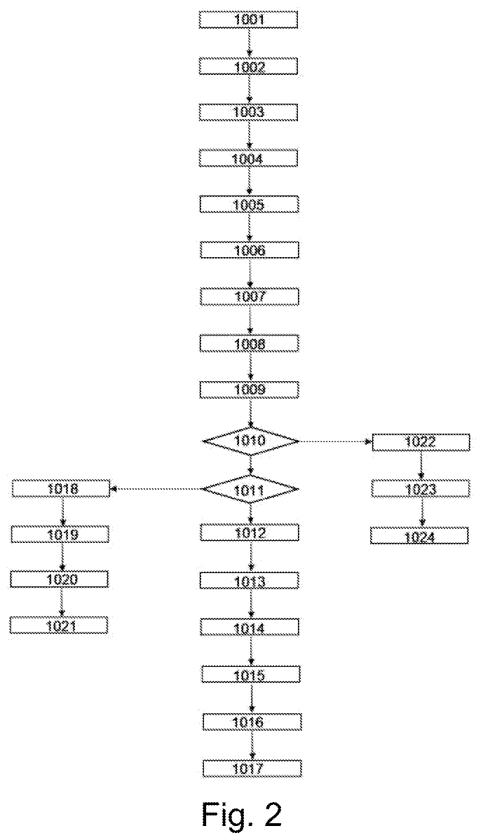

FIG. 3 shows flow of key injection method.

### REFERENCE NUMBERS

1. POS application
   1.1. UI/UX module
   1.2. L3 SDK layer
   1.3. L2 management module
   1.4. L2 Kernel
   1.5. Crypto engine module
   1.6. NFC antenna
2. Backend module
   2.1. Parameter management module
   2.2. Key management module
   2.3. Transaction network gateway
   2.4. Attestation and monitoring module
   2.5. ID&V component
   2.6. Database
   2.7. Hardware security module
3. acquirer
4. issuer bank
M: User mobile device
1001. installation of POS application providing making payment, onto user mobile device having near field communication feature,
1002. starting up of POS application on user mobile device and verification of initial attestation data,
1003. verification of merchant,
1004. generation of special keys unique for merchant,
1005. Downloading configuration and POS application parameters into user mobile device and completion of installation and getting POS application ready,
1006. Starting of sale transaction by means of UI/UX module, L3 SDK layer and L2 management module in POS application from POS application,
1007. receipt of data from said L3 SDK layer and L2 layer and preparation of EMV tags needed for authorization and encryption of sensitive data by crypto engine module providing running of cryptographic algorithms,
1008. submission of authorization request message to backend module managing POS application via L2 management module,
1009. re-encryption of data by hardware security module providing key management and communication security in backend module and submission of authorization request message to acquirer by transaction network gateway in backend module,
1010. delivery of authorization request response to transaction network gateway in backend module by acquirer,
1011. transmission of authorization request response from acquirer bank to L3 SDK layer in POS application by transaction network gateway in backend module.
1012. display of response of sale transaction result transmitted to L3 SDK layer in POS application by UI/UX module,
1013. Starting of void/refund transaction by means of UI/UX module, L3 SDK layer and L2 management module in POS application from POS application,
1014. receipt of data from said L3 SDK layer and L2 layer and preparation of EMV tags needed for void/refund transaction and encryption of sensitive data by crypto engine module providing running of cryptographic algorithms.
1015. submission of void/refund request message to backend module managing POS application via L2 management module,
1016. re-encryption of data by hardware security module and transmission of void/refund request message to transaction network gateway in backend module to acquirer bank,
1017. transmission of void/refund request response from acquirer bank to L3 SDK layer in POS application by transaction network gateway in backend module,
1018. Receipt of an error from POS application during step of transmission of authorization request response from acquirer bank to L3 SDK layer in POS application by transaction network gateway in backend module,
1019. transmission of CheckPOS request and reversal request of POS application to backend module by L2 management module,
1020. transmission of reversal request to POS application acquirer by backend module via transaction network gateway,
1021. transmission of reversal request response from acquirer bank to L3 SDK layer in POS application by transaction network gateway in backend module,
1022. receipt of error during step of delivery of authorization request response to transaction network gateway in backend module by acquirer bank,
1023. transmission of reversal request to acquirer by backend module via transaction network gateway,
1024. transmission of reversal request response from acquirer bank to L3 SDK layer in POS application via transaction network gateway in backend module.
A1. Generation of ACQ.PRODUCT key pair in hardware security module (2.7)
A2. Storing ACQ.PRODUCT keys in database (2.6)
A3. Placement of ACQ.PRODUCT.PUB key in L3 SDK layer (1.2) in whitebox form
A4. random generation of C.EXCH.Key by L3 SDK layer (1.2) and conversion of the key into whitebox form
A5. encryption of C.EXCH.Key by acquirer (3) public key
A6. transmission of C EXCH.Key encrypted by acquirer (3) public key by L3 SDK layer (1.2) with registration request during registration into POS application of user mobile device (M)
A7. Import of Client Exchange Key encrypted by Acquirer public key to hardware security module (2.7) by backend module (2)
A8. Generation of Host Exchange Key under Client Exchange Key in hardware security module (2.7) by backend module (2)
A9. Generation of Base Derivation Keys (BDK) in hardware security module (2.7) by backend module (2)
A10. Storing each BDK in database (2.6)
A11. Generation of IPEK.TATK (MAC), IPEK.TEK (Encryption), IPEK.TAK (Attestation), IPEK.TSK (session) keys under Host Exchange Key by backend module (2)
A12. Transmission of IPEK.TATK, IPEK.TEK, IPEK.TAK, IPEK.TSK keys in registration response under Host Exchange Key by backend module (2)
A13. Receipt of C.EXCH.Key (H.EXCH.Key), H.EXCH.Key (IPEK.TATK), H.EXCH.Key (IPEK.TEK), H.EXCH.Key (IPEK.TAK) and H,EXCH.Key (IPEK.TSK) at POS application (1)
A14. Decryption of Host exchange key by L3 SDK layer (1.2) by use of C EXCH Key.
A15. Decryption of IPEK key by L3 SDK layer (1.2) by use of H EXCH Key.
A16. Conversion of each IPEK key into whitebox form by L3 SDK layer (1.2)
A17. Storing of each key in crypto engine module (1.5) in whitebox form by L3 SDK layer (1.2),

### DETAILED DESCRIPTION OF THE INVENTION

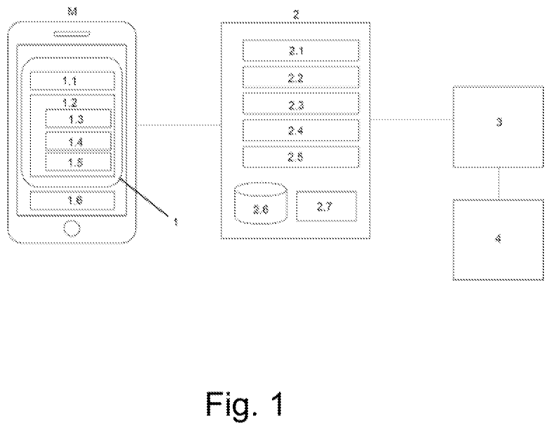

In this detailed description, novelty being subject of this invention has been disclosed solely for the purpose of better understanding of the subject and with samples described in a manner not causing any restrictive effect. Invention is a secure mobile payment and back office application method capable to accept contactless payment for commercial off the shelf devices, providing performance of functions of physical POS devices by mobile devices. A schematic view of the system disclosed under the invention is given in FIG. 1. According to it, the system comprises a UI/UX module (1.1) providing payment acceptance from user's mobile device (M) having near field communication feature and providing user interface, L3 SDK layer (1.2) managing user interface and work flows, L2 kernel (1.4) where core applications of payment schemes run, L2 management module (1.3) providing management of said L2 kernel (1.4), POS application (1) comprising crypto engine (1.5) providing security, key generation and running of cryptographic algorithms, parameter management module (2.1) managing said POS application (1) and providing management of EMV terminal parameters on mobile device (M), key management module (2.2) providing management of client keys on the mobile device (M), transaction network gateway (2.3) providing transmission of contactless payment transaction initiated on mobile device (M) to acquirer (3) in a secure way, attestation and monitoring module (2.4) checking authenticity of mobile device (M), performing fraud and security checks, ID&V component (2.5) providing integration of acquirer (3) with merchant, database (2.6) where key information is kept, hardware security module (2.7) providing key management and communication security.

In a preferred embodiment of our invention, said user mobile device (M) preferably comprises NFC antenna (1.6) for providing near field communication feature.

Main purpose of the system of the invention is to take place of physical POS devices. For that reason, the initial step for use of the invention is the establishment of relationship between merchant and acquirer (3). Merchant applies to acquirer (3) to use POS application (1). If application ends in affirmative consequence, acquirer (3) provides Merchant ID, Terminal ID and activation code to merchant for installation of POS application (1). Such details can be sent to merchant by e-mail or SMS. Preferably Google Play Store downloads merchant POS application (1) into user mobile device (M). When POS application (1) is opened by merchant, Merchant ID, Terminal ID and activation code are required for registration. When POS application (1) is opened, initial attestation data verification is also made at the same time. Attestation verifications is executed by Attestation& Monitoring module (2.4) in backend module (2).

After merchant enters required information, registration request is sent to backend module (2) by POS application (1). Backend module (2) calls for Verification API of POS application (1) bank acquirer (3) and sends these details for verification of registration request. acquirer (3) responds to verification request as per received information. Incoming reply is transmitted to POS application (1) by backend module (2). If verification is successful in the incoming reply, flow continues, otherwise, flow is terminated.

After successful verification, POS application (1) sends request for generation of configuration and key to backend module (2). This request is sent together with ACQ.PRODUCT.PUB (C.EXCH.Key) by L3 SDK layer (1.2). All flow performed upon incoming request is executed in compliance with unique key pattern of POS application (1). C.EXCH.Key is generated randomly by L3 SDK layer (1.2) and converted into whitebox form. C.EXCH.Key is encoded with ACQ.PRODUCT.PUB key. Backend module (2) imports C.EXCH.Key to hardware security module (2.7) in name of ACQ.PRODUCT.PUB key. Backend module (2) generates H.EXCH.Key in hardware security module (2.7) under C.EXCH.PUB. Backend module (2) generates Base Derivation Keys in hardware security module (2.7) for acquirer (3) (BDK.TEK, BDK.TAK. BDK.TSK, BDK.TATK). Backend module (2) generates IPEK.TAK, IPEK.TEK, IPEK.TATK, IPEK.TSK keys under H:EXCH.KEY from BDK in hardware security module (2.7). Backend module (2) sends IPEK.TATK, IPEK.TEK, IPEK.TAK, IPEK.TSK keys in registration response under Host Exchange Key. L3 SDK layer (1.2) solves host exchange key by C EXCH Key. L3 SDK layer (1.2) decryptseach IPEK key with H.EXCH.Key. L3 SDK layer (1.2) converts each IPEK key into whitebox form. L3 SDK layer (1.2) stores each key (WB_JPEK.TEK, WB_IPEK.TAK, WB_IPEK.TSK and WB_IPEK.TATK) in whitebox form in crypto module (1.5).

Backend module (2) also associated keys and parameters with user mobile device (M). Keys are generated specifically for each user mobile device (M). Keys and configuration parameters specific to user mobile device (M) are sent to user mobile device (M) by backend module (2). Management of keys and parameters is conducted by key management module (2.2) and parameter management module (2.1) in backend module (2). Merchant registration process is completed with transmission of keys and parameters to user mobile device (M), and user mobile device (M) of merchant becomes ready for receiving payment.

Sale transaction can be executed upon making user mobile device (M) ready for payment. Payment amount is entered from POS application (1). After amount is entered, a prompt stating that payment instrument (card) to make payment is to be read by user mobile device (M) in POS application (1). Consumers card is read by user mobile device (M). After card is read, EMV contactless transaction is made in POS application (1) and EMV tags required for authorization are made ready. Transaction attestation request is prepared in JSON format and sent to backend module (2). Backend module (2) encodes authorization request message with key belonging to acquirer (3) and sends to acquirer (3) in ISO message format. Authorization request message received by acquirer (3) is transmitted to issuer bank (4). issuer bank (4) checks authorization message. Approval or decline response is transmitted to acquirer (3). Response message received by acquirer (3) is sent to backend module (2). The reply is transmitted to POS application (1) by backend module (2). Result of transaction is displayed on POS application (1) display. Consumer is requested to enter e-mail or phone number for invoice. Information on if invoice data are to send by e-mail or SMS is sent to backend module (2) together with invoice data. This information is transmitted to acquirer (3) by backend module (2).

In case it is desired to void(cancel) or refund sale transaction, Void/refund menu is selected in POS application (1). RRN or ARC information is entered. EMV tags required for cancel/return operation is prepared by POS application (1). Void/refund request is prepared in JSON format and sent to backend module (2). This request is transmitted to acquirer (3) by backend module (2). Backend module (2) prepares request according to acquirer (3) void/refund message format and sends it. Response message received by backend module (2) from acquirer (3) is sent to POS application (1) in JSON format.

When transaction performed in the system is not completed successfully, in other words, result of transaction is not transmitted to POS application (1) successfully, reversal process can be initiated.

Reversal mechanism works in two ways. In the first one. POS application (1) starts reversal process, and in the second one backend module (2) starts the process. In the first one, process is started from POS application (1) EMV tags are prepared and authorization request message is transmitted to backend module (2). The authorization request is transmitted to acquirer (3) by backend module (2). Response message received by acquirer (3) for request message is sent to backend module (2). In case of timeout or system error in POS application (1) somehow while transmitting response to POS application (1) by backend module (2), reversal request is sent by checkPOS request by POS application (1). The incoming request is transmitted to acquirer (3) by backend module (2) and reversal response from acquirer (3) is transmitted to POS application (1) by backend module (2) again. As long as response to reversal request is not received by POS application (1), a new sale operation is not started.

In case reversal request is started by backend module (2), backend module does not receive expected authorization response from acquirer (3) and start reversal process without returning to POS application (1).

Key list used in our invention is as follows:
ACQ.PRODUCT.PRI: Acquirer Product RSA Key→stored in database (2,6) under Key Block LMK.
ACQ.PRODUCT.PUB: Whitebox Acquirer Product RSA Public Key→stored in POS application (1).
C.EXCH.Key: Client Exchange Key→generated randomly and sent to backend module (2) under ACQ_PRODUCT_PUB key. Imported into hardware security module (2.7) and used to encrypt H.EXCH.Key.
H.EXCH.Key: Host Exchange Key→is AES key generated by backend module (2). Encrypted by C.EXCH.Key and used for SDK based IKEYs encryption.
WB.C.REG.Key: Client Registration Key→is the key used for encrypting initial registration request data generated at random.
WB.C.IATTEST.Key: Client Initial Attestation Key→is the key used for encrypting initial attestation data generated at random.
BDK.TEK: Base Derivation Key for TEK→used to generate IPEK.TEK key.
BDK.TAK: Base Derivation Key for TAK→used to generate IPEK.TAK key.
BDK. TSK: Base Derivation Key for TSK→used to generate IPEK.TSK key.
BDK:TATK: Base Derivation Key for TATK→used to generate IPEK.TATK key.
IPEK.TEK: Initial Terminal Encryption Key→is the key used for encrypting sensitive card holder data by L3 SDK layer (1.2) generated by backend module (2).
IPEK.TAK: Initial Terminal Authentication Key→is the key used for computing MAC value by L3 SDK layer (1.2) generated by backend module (2).
IPEK.TSK: Initial Terminal Session Key→is the key used for generating session key by L3 SDK layer (1.2) generated by backend module (2).
IPEK.TATK: Initial Terminal Attestation Key→is the key used for encrypting attestation data by L3 SDK layer (1.2) generated by backend module (2).
WB.IPEK.TEK: Initial Terminal Encryption Key in Whitebox form
WB.IPEK.TAK: Initial Terminal Authentication Key in Whitebox form
WB.IPEK.TSK: Initial Terminal Session Key in Whitebox form
WB. IPEK.TATK: Initial Terminal Attestation Key in Whitebox form
WB.KEK.LOCAL: Local Key Encryption Key in Whitebox form→used for encryption and decryption operations in case of storage of WB IPEK key internally.
WB.MSession.Key: Session based key in Whitebox form→key generated based on Session data.

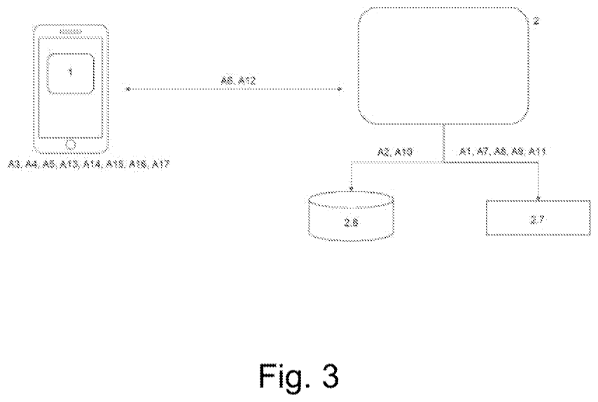

Schematic view of Key Injection flow used in our invention is shown in FIG. 3. The processes executed according to it are given below.
A1. ACQ.PRODUCT key pair is generated to hardware security module (2.7)
A2. ACQ.PRODUCT keys are stored in database (2.6)
A3. ACQ.PRODUCT.PUB key is placed in L3 SDK layer (1.2) in whitebox form
A4. C.EXCH.Key is generated by L3 SDK layer (1.2) at random and the key is converted into whitebox form.
A5. C.EXCH.Key is encrypted by acquirer (3) public key.
A6. C EXCH.Key encrypted by acquirer (3) public key by L3 SDK layer (1.2) is sent with registration request during registration into POS application (1) of user mobile device (M).
A7. Client Exchange Key encrypted by Acquirer public key is imported to hardware security module (2.7) by backend module (2).
A8. Backend module (2) generates host Exchange Key under Client Exchange Key in hardware security module (2.7).
A9. Backend module (2) generates Base Derivation Keys (BDK) in hardware security module (2.7). The keys are BDK.TATK, BDK.TEK, BDK.TAK, BDK.TSK
A10. Each is stored BDK in database (2.6).
A11. Backend module (2) generates IPEK.TATK (MAC), IPEK.TEK (Encryption), IPEK.TAK (Attestation), IPEK.TSK (session) keys under Host Exchange Key.
A12. Backend module (2) transmits IPEK.TATK, IPEK.TEK, IPEK.TAK, IPEK.TSK keys in registration response under Host Exchange Key.
A13. C.EXCH.Key (H.EXCH.Key), H.EXCH.Key (IPEK.TATK), H.EXCH.Key (IPEK.TEK), H.EXCH.Key (IPEK.TAK) and H,EXCH.Key (IPEK. TSK) is received at POS application.
A14. L3 SDK layer (1.2) decrypts Host exchange key by use of C EXCH Key.
A15. L3 SDK layer (1.2) decrypts IPEK key by use of H EXCH Key.
A16. L3 SDK layer (1.2) converts each IPEK key into whitebox form.
A17. L3 SDK layer (1.2) stores each key in crypto engine module (1.5) in whitebox form. (WB_IPEK.TATK, WB_IPEK.TEK, WB_IPEK.TAK and WB_IPEK.TSK)

Attestation policy applied in our invention is as follows:

POS application (1) generates two data sets, mainly initial attestation and general attestation data. Initial attestation is sent when POS application (1) is started initially and before conduct of key injection. General attestation is sent when POS application (1) is opened, and key and injection is completed. In addition, general attestation is transmitted to backend module (2) in 1-5 minutes intervals at random.

Initial attestation data is encrypted with WB.C.IATTEST.Key. POS application (1) transmits C.IATTEST.Key to backend module (2) under ACQ.PRODUCT.PUB key with initial attestation request, backend module (2) imports C.IATTEST.Key and uses for decryption of initial attestation data.

General attestation data is encrypted with WB.IPEK.TATK key. Encrypted attestation data is sent to backend module (2) together with KSN value. Backend module (2) decrypts attestation with BDK TATK and checks KSN.

Attestation Data comprises following fields.
Acquirer id
Application: appVersion
Application: packageName
Application: permissions
Application: sdkVersion
Application: signature
Device: availableInternalStorage
Device: fingerprint
Device: imei
Device: manufacturer
Device: model
Device: osName
Device: osVersion
Device: remainingBatteryPercentage
Device: usingMemoryPercentage
Device: UniqueId
Security: appTamper
Security: debugger
Security: emulator
Security: hooking
Security: root
Timestamp

Backend module (2) conducts checks related to coming fields and in case of discovering any negativity, gives error message and takes various actions such as temporary blocking user mobile device (M), error return to API calls, crash of POS application (1).

1. A secure mobile payment and back office application system capable to accept contactless payment for commercial off the shelf devices, providing performance of functions of physical POS devices by mobile devices, the system comprising:
a POS application providing payment acceptance with a mobile device of a user having close area communication feature and comprising:
a UI/UX module providing a user interface,
an L3 SDK layer managing user interface and workflows,
an L2 kernel where core applications of payment schemes work,
an L2 management module providing management of said L2 kernel, and
a crypto engine module providing generation of security, key and cryptographic algorithm operation,
a backend module managing said POS application and comprising:
a parameter management module providing management of EMV terminal parameters on the mobile device,
a key management module providing management of client keys on the mobile device,
a transaction network gateway providing secure transmission of contactless payment transaction initiated on the mobile device to an acquirer in a secure way,
an attestation and monitoring module verifying the mobile device and conducting security and fraud checks,
an ID&V component providing integration of the acquirer bank with merchant,
a database storing key details,
a hardware security module providing key management and communication security,
the user mobile device running said POS application and having a near field communication feature.

2. The mobile POS system according to claim 1, comprising an NFC antenna providing the near field communication feature of said user mobile device.

3. A secure mobile payment and back office application method capable to accept contactless payment for commercial off the shelf devices, providing performance of functions of physical POS devices by mobile devices, the method comprising the steps of:
installation (1001) of a POS application providing making payment, onto a user mobile device having near field communication feature,
starting up of the POS application on the user mobile device and verification of initial attestation data (1002),
verification of a merchant (1003),
generation of special keys unique for the merchant (1004),
downloading configuration and POS application parameters into user the mobile device and completion of installation and getting the POS application ready (1005),
performing a sale transaction by the POS application as follows:
starting of the sale transaction by means of a UI/UX module, L3 SDK layer and L2 management module in the POS application from the POS application (1006),
receipt of data from said L3 SDK layer and L2 kernel and preparation of EMV tags needed for authorization and encryption of sensitive data by a crypto engine module providing running of cryptographic algorithms (1007),
transmission of an authorization request message to a backend module that manages the POS application via the L2 management module (1008),
re-encryption of data by a hardware security module providing key management and communication security in the backend module and submission of an authorization request message to an acquirer bank by a transaction network gateway in the backend module (1009),
transmission of an authorization request response to the transaction network gateway in the backend module by the POS application acquirer bank (1010),
transmission of the authorization request response from acquirer bank to the L3 SDK layer in the POS application by the transaction network gateway in the backend module (1011),
display of a response of sale transaction result transmitted to the L3 SDK layer in the POS application by the UI/UX module (1012),
performing void/refund operation by the POS application (1) as follows:
starting of void/refund transaction by means of the UI/UX module, L3 SDK layer and L2 management module in the POS application from the POS application (1013),
receipt of data from said L3 SDK layer and L2 kernel and preparation of EMV tags needed for void/refund and encryption of sensitive data by crypto engine module providing running of cryptographic algorithms (1014),
transmission of void/refund request message to the backend module that manages the POS application via the L2 management module (1015),
re-encryption of data by hardware security module and transmission of void/refund request message to the transaction network gateway in the backend module to acquirer bank (1016),
transmission of void/refund request response from the acquirer bank to L3 SDK layer in the POS application by the transaction network gateway in the backend module (1017),
performing reversal transaction by the POS application as follows:
receiving an error (1018) from the POS application during transmission of the authorization request response from the acquirer bank to the L3 SDK layer in the POS application by the transaction network gateway in the backend module (1011),
transmission of a CheckPOS request and reversal request of the POS application to the backend module by the L2 management module (1019),
transmission of reversal request to the acquirer by the backend module via the transaction network gateway (1020),
transmission of the reversal response from the acquirer bank to the L3 SDK layer in the POS application by the transaction network gateway in the backend module (1021),
execution of the reversal transaction by the backend module as follows:
receiving an error (1022) during the process step of transmission of authorization request response to the transaction network gateway in the backend module by the acquirer bank (1010),
transmission of the reversal request to the acquirer by the backend module via the transaction network gateway (1023),
transmission of the reversal response from the acquirer bank to the L3 SDK layer in the POS application by the transaction network gateway in the backend module (1024).

4. The mobile POS method according to claim 3, wherein the process of verification of merchant (1003) during initial opening of the POS application comprises the steps of:
entering a Merchant ID, terminal ID and activation code sent to the merchant by the acquirer bank for registration of the merchant enterprise by the POS application UI/UX module,
transmission of entered details to the backend module by the L3 SDK layer working on the POS application and recalling the acquirer bank Verification API by ID&V component providing integration of the backend module and verification of registration details,
transmission of verification reply of the acquirer bank via the ID&V component in the backend module to the POS application and display of a result by means of the UI/UX module,
proceeding flow if verification is successful,
termination of flow if verification is incorrect.

5. The mobile POS method according to claim 3, wherein generation of keys specific to the merchant (1004) process step comprises the steps of:
submission of request with ACQ.PRODUCT.PUB (C.EXCH.Key) data to the backend module by means of the L3 SDK layer by the POS application for configuration and key generation,
importing of C.EXCH.Key to hardware security module in name of ACQ.PRODUCT.PUB key by the backend module,
generation of generates H.EXCH.Key in hardware security module under C.EXCH.PUB by the backend module,
generation of Base Derivation Keys in hardware security module for acquirer by backend module,
generation of IPEK.TAK, IPEK.TEK, IPEK.TATK, IPEK.TSK keys under H:EXCH.KEY from BDK in hardware security module by the backend module,
transmission of IPEK.TATK, IPEK.TEK, IPEK.TAK, IPEK.TSK keys in registration response under Host Exchange Key by the backend module,
resolution of host exchange key by C EXCH Key by the L3 SDK layer,
resolution of each IPEK key with H.EXCH.Key by the L3 SDK layer,
conversion of each IPEK key into whitebox form by the L3 SDK layer,
storing of each key (WB_IPEK.TEK, WB_IPEK.TAK, WB_IPEK.TSK and WB_IPEK.TATK) in whitebox form in the crypto module by the L3 SDK layer,
association of keys and parameters to the related user mobile device by means of parameter management module and key management module of the backend module,
transmission of keys and configuration parameters specific to the user mobile device to the user mobile device by the backend module by means of the parameter management module,
downloading keys and configuration parameters specific to the user mobile device into the user mobile device by means of the L3 SDK layer and the crypto engine module.

6. The mobile POS method according to claim 3, wherein initiation of sale operation from the POS application step (1006) comprises the steps of:
entering an amount to be paid from the UI/UX module of the POS application,
display of a prompt stating that payment instrument where payment will be made is to be read to the user mobile device by means of the UI/UX module and the L3 SDK layer on the POS application,
reading payment instrument to the user mobile device by the consumer.

7. The mobile POS method according to claim 3, wherein the initial attestation data verification step comprises the steps of:
encryption of initial attestation data with WB.C.IATTEST.Key by means of the L3 SDK layer and the crypto engine module on the POS application,
transmission of C.IATTEST.key under ACQ.PRODUCT.PUB key by the POS application together with the initial attestation request to the backend module,
importing of C.IATTEST.Key by the backend module by means of the attestation and the monitoring module and the hardware security module and decryption of initial attestation data.

8. The mobile POS method according to claim 3, comprising the steps of:
encryption of general attestation data with WB.IPEK.TATK Key by the POS application by means of the L3 SDK layer and the crypto engine module,
transmission of encrypted attestation data to the backend module together with a KSN value,
decryption of attestation data with BDK.TATKT and checking the KSN by the backend module by means of the attestation and monitoring module and the hardware security module.

9. The mobile POS method according to claim 3, wherein the attestation data comprises fields and steps of:
Acquirer id,
Application: appVersion,
Application: packageName,
Application: permissions,
Application: sdkVersion,
Application: signature,
Device: availableInternalStorage,
Device: fingerprint,
Device: imei,
Device: manufacturer,
Device: model.
Device: osName,
Device: osVersion,
Device: remainingBatteryPercentage,
Device: usingMemoryPercentage,
Device: UniqueId,
Security: appTamper,
Security: debugger,
Security: emulator,
Security: hooking,
Security: root, and
Timestamp,

10. The mobile POS method according to claim 3, that wherein communication of the user mobile device with the payment instrument is provided by NFC antenna.
